(19) United States
(12) Patent Application Publication
(10) Pub. No.: US 2007/0262661 A1
(43) Pub. Date: Nov. 15, 2007

(54) Miniature Bipolar Single-Phase Generator

(76) Inventor: Chun Ai, Chongqing (CN)

Correspondence Address: CONNOLLY BOVE LODGE & HUTZ, LLP, P O BOX 2207, WILMINGTON, DE, 19899, US

(21) Appl. No.: 11/575,926

(22) PCT Filed: Sep. 26, 2005
(86) PCT No.: PCT/CN05/01561

§ 371 Date: Apr. 13, 2007

(30) Foreign Application Priority Data
Feb. 4, 2005 (CN) 200510020380.6

(51) Int. Cl. H02K 7/14

(52) U.S. Cl. 310/51; 310/40 MM

(57) ABSTRACT

The present invention provides a miniature bipolar single-phase generator composed of a rotor (1) and a stator (2), with two sets of damping windings arranged on the core of the rotor (1). Each of the two sets of damping windings is composed of damping strips (3) and a damping board (4), the damping board (4) disposed on both ends of the core, while the damping strips (3) passed in the axial direction through the core, with both ends of each damping strip connected to the damping board (4) reliably. The winding coil on the stator has an equidistant bipolar winding structure. An angle of 3°˜15° is formed between the winding slot (1a) on the core of the rotor (1) and the wire-embedding slot on the core of the stator (2). Axial grooves are distributed over the outer surface of the core of the stator. The present utility model has a stable output voltage with a good waveform more approximate to a sine wave, which is more adaptable to a capacitive load, and can help to prolong the service life of electrical appliance, thus the field of application of the generator becomes wider.

### TECHNICAL FIELD

The present invention relates to a generator, particularly to a miniature bipolar single-phase generator.

### BACKGROUND ART

At present, both the winding slot of the rotor and the wire-embedding slot of the stator of the miniature bipolar single-phase generator (0.45 KW˜18 KW) on the market have a straight slot structure, i.e. both the central line of the winding slot of the rotor and that of the wire-embedding slot of the stator are parallel to the axial line of the generator, therefore no angle is formed between the coil of the rotor and the output winding embedded in the core of the stator. When the generator is in operation, an odd order harmonic such as the 3^{rd}, 5^{th} and 7^{th} and the like has a great influence on the output voltage waveform, causing it so poor to be the shape of serration, with the sinusoidal distortion rate usually between 15%˜25%. There is a good deal of harmonics in the waveform, thus making a significant impact on electrical appliance, especially a capacitive load, and causing the electrical appliance to break down earlier than normal, so the field of application of said type of generator is limited to a certain degree.

### CONTENTS OF THE INVENTION

An object of the present invention is to provide a miniature bipolar single-phase generator, which solves the problems of poor output voltage waveform, high sinusoidal distortion rate of the waveform and limited field of application of the prior art miniature bipolar single-phase generator.

To solve the above problems, the miniature bipolar single-phase generator according to the present invention includes a rotor and a stator, with two sets of damping windings arranged on the core of the rotor, each of the two sets of damping windings composed of damping strips and a damping board. The damping board is disposed on both ends of the core, while the damping strips are passed in the axial direction through the core with both ends of each damping strip connected to the damping board reliably. The winding coil on the stator has an equidistant bipolar winding structure.

It would be preferable that the number of the damping strips in each of the two sets of damping windings on the above core of the rotor is 4˜8, the cross section of each of the damping strips is circular with a diameter between 2˜8 mm, and the thickness of the damping board is 1˜8 mm.

It would be preferable that an angle of 3°˜15° is formed between the winding slot on the above core of the rotor and the wire-embedding slot on the core of the stator.

It would be preferable that axial grooves are distributed over the outer surface of the above core of the stator.

The present invention, as the output voltage waveform is affected by the magnetic force distribution, after two sets of damping windings are mounted on the core of the rotor, enables the distribution of the rotor magnetic line to achieve the optimum, weakens the influence of the negative-sequence magnetic field produced by the output winding of the stator on the waveform, and can decrease the alternating and the direct impedance of the rotor, reduce the hysteresis vortex loss and the temperature rise of the rotor, thereby achieving the purpose of improving the magnetic path and the output waveform. The equidistant bipolar winding structure adopted for the winding coil allows the magnetic field of the yoke of the stator to be more homogeneous. The magnetic field formed by the primary output winding on the circumference of the stator assumes a sinusoidal distribution, lessening the 3^{rd}, 5^{th} and 7^{th} harmonics' influence on the output voltage waveform, thereby allowing the output voltage waveform, loaded and non-loaded, to be more approximate to a sine wave. Its waveform distortion rate is compared with the conventional miniature bipolar single-phase generator as follows:

State of Load

| Type | Loaded | Non-loaded |
|---|---|---|
| Conventional Generator | 23%˜27% | 11%˜13% |
| The Present Invention | 4.6%˜4.8% | 2.6%˜3% |

It can be seen from the above table that: on the basis of guaranteeing other output performances, the sinusoidal distortion rate of the output voltage waveform of the generator can be controlled within 5%, thus greatly improving the output voltage waveform. Therefore, the field of application of the miniature bipolar single-phase generator becomes wider and the adaptability to a capacitive load can be enhanced greatly.

The prominent effect of the present invention is: a stable output voltage with a good waveform more approximate to a sine wave, which is more adaptable to a capacitive load, and can help to prolong the service life of electrical appliance, so the field of application of the generator becomes wider.

### DESCRIPTION OF FIGURES

FIG. 1 is an exploded view of the present invention with an omitted winding coil on rotor 1 and a fan denoted by sign 7;

FIG. 2 is a schematic diagram of the structure of the core of the rotor 1 in FIG. 1;

FIG. 3 is a front view of the stator 2 in FIG. 1;

FIG. 4 is a plan view of FIG. 3;

FIG. 5 is a schematic diagram of the wire-embedding principle of the equidistant bipolar winding of the coil of the stator 2 according to the present invention.

### MODE OF CARRYING OUT THE INVENTION

The present invention is further explained through figures in combination with specific embodiments:

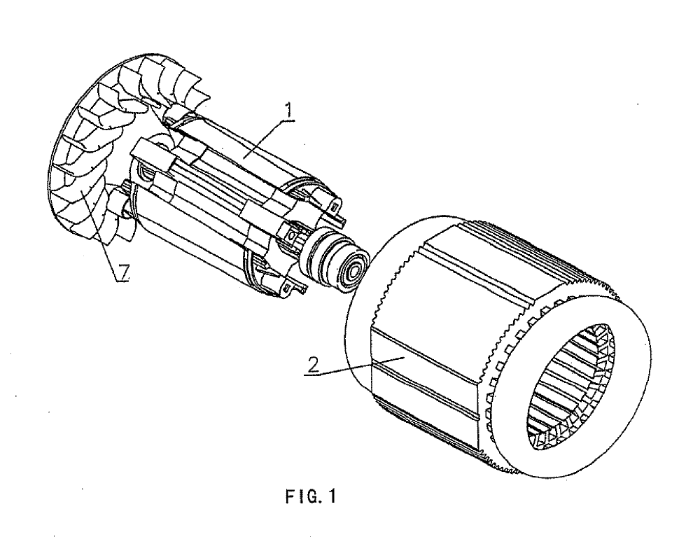

As shown in FIG. 1 to FIG. 5, there is a 12 KW miniature bipolar single-phase generator composed of a rotor 1 and a stator 2. Two sets of damping windings are arranged on the core of the rotor 1, each of the two sets of damping windings composed of damping strips 3 and a damping board 4. The damping board 4 is disposed on both ends of the core, while the damping strips 3 are passed in the axial direction through the core, with both ends of each damping strip welded (spot welding) on the damping board 4 reliably. A winding coil 2a on the stator 2 has an equidistant bipolar winding structure.

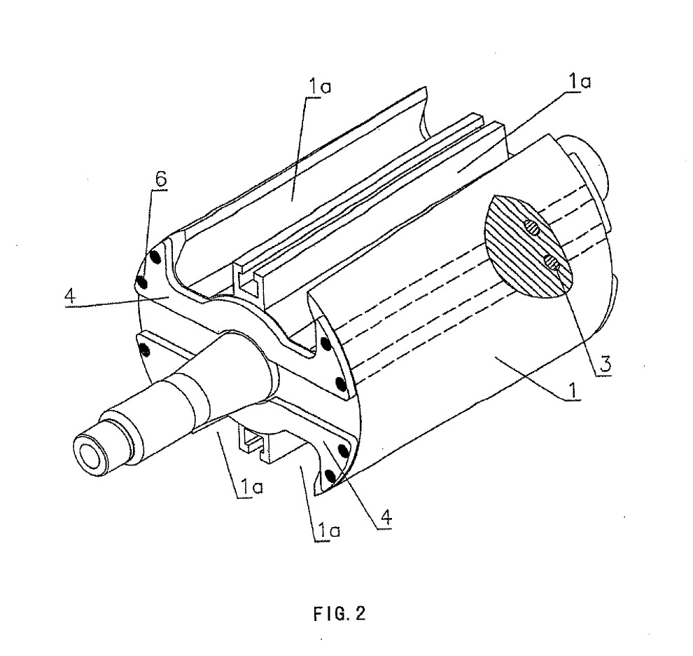

In FIG. 2, the number of the damping strips 3 in each of the two sets of damping windings on the core of the rotor 1 is 4. The cross section of each of the damping strips 3 is circular with a diameter between 2˜8 mm, while the thickness of the damping board 4 is 1˜8 mm. The damping strips 3 and the damping board 4 are made of non-ferrous metals, such as aluminum or copper. The sign 6 in the figure indicates a welding point between the damping board 4 and a damping strip 3.

An angle of 3°˜15° is formed between the winding slot 1a on the core of the rotor 1 and the wire-embedding slot 2b on the core of the stator 2. To achieve this purpose, either the winding slot 1a on the core of the rotor 1 is rotated an angle of 3°˜15° with respect to the axial line of the rotor to turn the wire-embedding slot 2b on the core of the stator 2 into a straight slot, and vice versa, or the winding slot 1a on the core of the rotor 1 and the wire-embedding slot 2b on the core of the stator 2 are both rotated an angle of a certain degree with respect to the axial line of the generator and finally an angle of 3°˜15° is formed between the winding slot 1a on the core of the rotor 1 and the wire-embedding slot 2b on the core of the stator 2. In this way, an angle is formed between the rotor 1 and the output winding embedded in the core of the stator 2, thereby weakening the influence of odd order harmonics on the output voltage waveform and making the output voltage waveform more approximate to a sine wave.

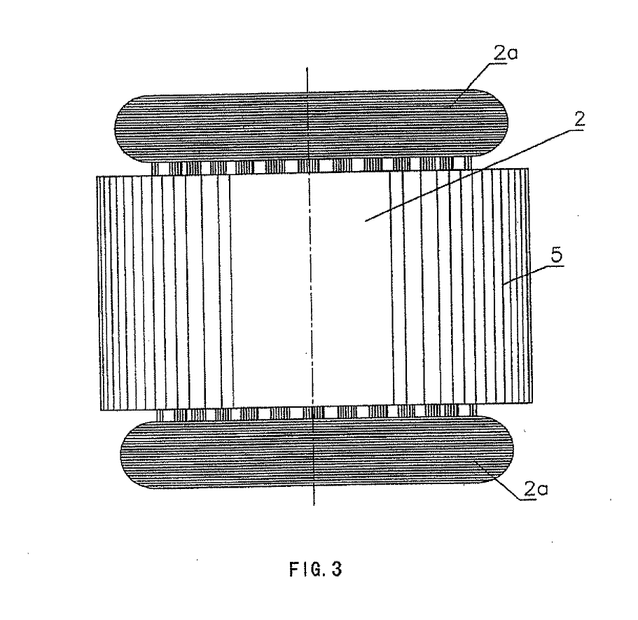

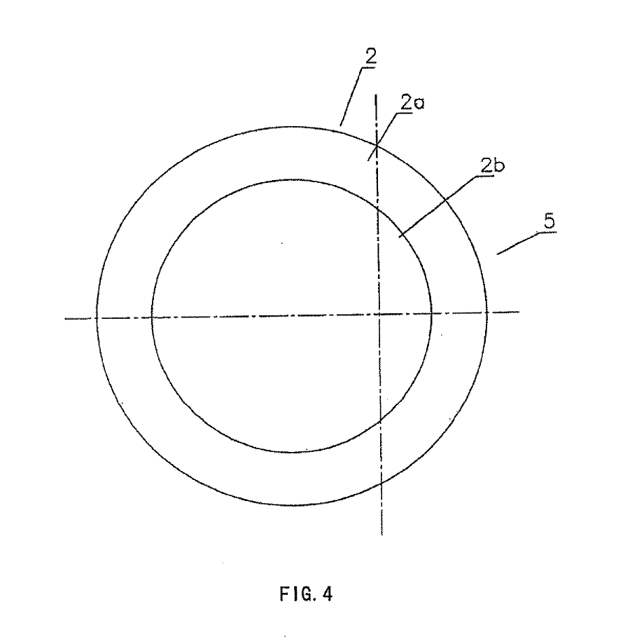

From FIG. 3 and FIG. 4 it can be further seen that axial grooves 5 are distributed over the outer surface of the core of stator 2. The axial grooves 5 can effectively improve the magnetic path of the yoke of the stator 2 and enlarge the heat radiation area of the external cylindrical surface of the core of the stator 2, thus the temperature rise of the stator 2 can be effectively improved, so that the quality of the waveform of the output voltage of the generator is increased.

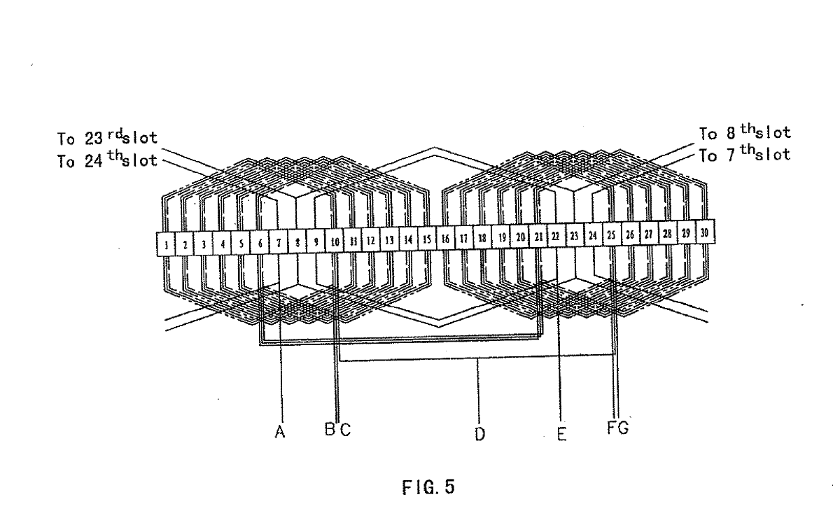

FIG. 5 is a schematic diagram illustrating the wire-embedding principle of the equidistant bipolar winding of the stator 2 according to the present invention. The number of slots of the wire-embedding slot 2b in the figure is 30, which is numbered successively with Arabic numbers 1˜30.

Real lines denote the primary winding 1, while the broken lines denote the sample winding, with spans of 1˜10, 2˜11, . . . , 6˜15 respectively forming the N Pole, the S Pole and so on. The 7^{th}, 8^{th}, 9^{th}, 22^{nd}, 23^{rd} and 24^{th} slots are secondary windings denoted by dash-dot-dot lines. A to F are external connecting terminals (terminal A and D are used for yellow wires of 0.75 mm², terminal B and F for a red and a blue wire of 1.5 mm², terminal brown wire of 0.75 mm², terminal E for a blue wire of 0.75 mm²).

1. A miniature bipolar single-phase generator, comprising a rotor (1) and a stator (2), characterised in that two sets of damping windings are arranged on the core of the rotor (1), each of the two sets of damping windings is composed of damping strips (3) and a damping board (4), the damping board (4) disposed on both ends of the core, while the damping strips (3) passed in the axial direction through the core, with both ends of each damping strip connected to the damping board (4) reliably; a winding coil (2a) on the stator (2) has an equidistant bipolar winding structure.

2. The miniature bipolar single-phase generator according to claim 1, wherein the number of the damping strips (3) in each of the two sets of damping windings on the core of the rotor (1) is 4˜8, the cross section of each of the damping strips (3) is circular with a diameter between 2˜8 mm, and the thickness of the damping board (4) is 1˜8 mm.

3. The miniature bipolar single-phase generator according to claim 1, wherein an angle of 3°˜15° is formed between the winding slot (1a) on the core of the rotor (1) and the wire-embedding slot (2b) on the core of the stator (2).

4. The miniature bipolar single-phase generator according to claim 1, wherein axial grooves (5) are distributed over the outer surface of the core of the stator (2).

5. The miniature bipolar single-phase generator according to claim 3, wherein axial grooves (5) are distributed over the outer surface of the core of the stator (2).

6. The miniature bipolar single-phase generator according to claim 2, wherein an angle of 3°˜15° is formed between the winding slot (1a) on the core of the rotor (1) and the wire-embedding slot (2b) on the core of the stator (2).

7. The miniature bipolar single-phase generator according to claim 2, wherein axial grooves (5) are distributed over the outer surface of the core of the stator (2).

8. The miniature bipolar single-phase generator according to claim 6, wherein axial grooves (5) are distributed over the outer surface of the core of the stator (2).
